(19) United States
(12) Patent Application Publication
(10) Pub. No.: US 2002/0180447 A1
(43) Pub. Date: Dec. 5, 2002

(54) Fuel cell voltage monitoring system and the method thereof

(76) Inventors: Stephane Masse, Toronto (CA); Ravi B. Gopal, Toronto (CA)

Correspondence Address: H. Samuel Frost, Bereskin & Parr, 40 King Street West, Box 401, Toronto, ON, M5H 3Y2, CA

(21) Appl. No.: 09/865,562

(22) Filed: May 29, 2001

(51) Int. Cl. G01N 27/416

(52) U.S. Cl. 324/433

(57) ABSTRACT

This invention discloses a system and method for monitoring the voltage of a fuel cell in a fuel cell stack. The system comprises a plurality of differential amplifiers, a switching network, an analog to digital converter and a controller. The system may further include a remote PC. Each differential amplifier has a high common-mode rejection ratio. The differential amplifiers are connected to terminals in the fuel cell stack at which the voltage is to be measured. An output of a single differential amplifier is chosen by the switching network, under the direction of the controller, and converted to digital values by the analog to digital converter. The digital values are used by the controller to calculate the cell voltage of the fuel cell. The controller also controls the analog to digital converter. The invention further comprises a calibration method and apparatus which are used to calibrate the measurement system before performing voltage measurements on the fuel cell stack. This invention allows the cell voltage of a fuel cell with almost any common-mode voltage to be measured using readily available differential amplifiers.

### FIELD OF THE INVENTION

The present invention relates to a voltage monitoring system and a method for measuring individual cell voltages. The invention has particular, but not exclusive, application to a fuel cell stack in which fuel cells are stacked in series.

### BACKGROUND OF THE INVENTION

A fuel cell is an electrochemical device that produces an electromotive force by bringing the fuel (typically hydrogen) and an oxidant (typically air) into contact with two suitable electrodes and an electrolyte. A fuel, such as hydrogen gas, for example, is introduced at a first electrode where it reacts electrochemically in the presence of the electrolyte to produce electrons and cations in the first electrode. The electrons are circulated from the first electrode to a second electrode through an electrical circuit connected between the electrodes. Cations pass through the electrolyte to the second electrode. Simultaneously, an oxidant, such as oxygen or air is introduced to the second electrode where the oxidant reacts electrochemically in the presence of the electrolyte and a catalyst, producing anions and consuming the electrons circulated through the electrical circuit. The cations are consumed at the second electrode. The anions formed at the second electrode or cathode react with the cations to form a reaction product. The first electrode or anode may alternatively be referred to as a fuel or oxidizing electrode, and the second electrode may alternatively be referred to as an oxidant or reducing electrode. The half-cell reactions at the first and second electrodes respectively are:

H₂→2H⁺⁺²e⁻ (1)

1/20O₂+2H⁺+2e⁻→H₂O (2)

The external electrical circuit withdraws electrical current and thus receives electrical power from the fuel cell. The overall fuel cell reaction produces electrical energy as shown by the sum of the separate half-cell reactions shown in equations 1 and 2. Water and heat are typical by-products of the reaction.

In practice, fuel cells are not operated as single units. Rather, fuel cells are connected in series, either stacked one on top of the other or placed side by side. The series of fuel cells, referred to as a fuel cell stack, is normally enclosed in a housing. The fuel and oxidant are directed through manifolds in the housing to the electrodes. The fuel cell is cooled by either the reactants or a cooling medium. The fuel cell stack also comprises current collectors, cell-to-cell seals and insulation while the required piping and instrumentation are provided external to the fuel cell stack. The fuel cell stack, housing and associated hardware constitute a fuel cell module.

Various parameters have to be monitored to ensure proper fuel cell stack operation. One of these parameters is the voltage across each fuel cell in the fuel cell stack hereinafter referred to as cell voltage. Therefore, differential voltage measurement is required at the two terminals (i.e. anode and cathode) of each fuel cell in the fuel cell stack. However, since fuel cells are connected in series, and typically in large number, the voltages at some terminals will be too high for any currently available semiconductor measuring device to directly measure. For example, for a fuel cell stack consisting of 100 cells with each cell voltage at 0.95 V, the actual voltage on the negative terminal (cathode) of the top cell will be 94.05 V (i.e. 0.95*100−0.95). As such, the voltage exceeds the maximum allowable input voltage of current differential amplifiers commonly used for measuring voltage.

Various efforts have been made to overcome this problem. One method for monitoring high cell voltages is disclosed by Becker-Irvin (U.S. Pat. No. 5,914,606) who teaches monitoring cell voltage with the aid of voltage dividers. The voltage dividers are connected to measurement points on a stack of cells. The voltage dividers reduce the voltage at each measurement point so that each voltage is low enough to be an input to a conventional differential amplifier. When the voltage dividers are “closely matched”, the output of the differential amplifier is directly proportional to the differential voltage between the pair of points at which the voltage dividers are connected. Hence the differential voltage between those two points can be determined. By selecting the “ratio” of each voltage divider, the system can be used to measure differential voltages in the presence of different common-mode voltages.

However, there are two problems when the cell voltage is monitored with this system. Firstly, since the cells are connected in series, the voltage of the cells near the top of the series connection (i.e. furthest away from the reference potential) must be divided down (i.e. reduced) using extremely high-ratio voltage dividers in order to provide voltages that can be read by the same voltage-measuring circuit which measures the cell voltages of the cells near the bottom of the series connection. Thus, monitoring high voltages requires very high precision resistors in the high-ratio voltage dividers in order to reduce the voltages on each terminal of the cell being measured by the same amount. Secondly, any deviation in the resistance of the resistors in the voltage dividers will cause an impedance mismatch in the Thevenin equivalent of the voltage dividers which will affect the ability of the differential amplifier to properly measure the cell voltage. Therefore, great care must be taken to precisely match the resistances of the resistors used in the voltage dividers. This results in a voltage measurement system with increased cost and decreased efficiency.

Another system for monitoring high voltages was disclosed by Flohr et al. (U.S. Pat. No. 5,712,568). Flohr teaches the use of an optical isolation technique to separate the voltage measurement process. Unfortunately, this method is both costly and difficult to implement. James (U.S. Pat. No. 6,140,820) also disclosed a voltage monitoring system that used isolation methods incorporating a multiplexer and differential inputs. However, this voltage monitoring system also suffers from impedance mismatch and reduced accuracy.

As can be seen, the above methods do not provide a simple and cost-efficient system for monitoring cell voltage. This is unfortunate since, in the field of fuel cell technology, as fuel cell stacks become larger and more complex, there is an increasing need for simple and accurate cell voltage measurement systems. For instance, it is currently technically difficult to achieve an accurate cell voltage measurement at a reasonable cost for any fuel cell stack that exceeds 40 fuel cells.

### SUMMARY OF THE INVENTION

In order to overcome the problems associated with the current methods of measuring cell voltage, the present invention provides a novel circuit and method for monitoring the voltage of each fuel cell within a fuel cell stack. The fuel cell voltage monitoring circuit is cost effective and easy to operate.

In accordance with the present invention, there is provided a system for monitoring at least one cell voltage of an electrochemical device for a plurality of cells connected in series, wherein the system comprises:

a plurality of differential amplifiers, each differential amplifier, having two inputs and one output, wherein the inputs are connected, in use, to the plurality of cells;

a switching network having a plurality of inputs and one output, the inputs of the switching network connected to the outputs of the differential amplifiers;

an analog to digital converter having an input connected to the output of the switching network and adapted to provide digital values indicative of the voltages measured by the plurality of differential amplifiers; and,

a controller connected to the switching network and the analog to digital converter to control the operation of the switching network and the analog to digital converter, wherein the controller is further adapted to receive the digital values from the output of the analog to digital converter.

Preferably, each differential amplifier has a high common-mode rejection ratio. More preferably, each differential amplifier can reject a common-mode voltage of 200 V.

The system may further include a calculating means, connected to the output of one of the analog to digital converter and the controller, to calculate the at least one cell voltage based on the digital values. Further, the controller may include a calculating means. A microprocessor may be used as the controller. The system may further comprise a computer that is connected to the controller.

In another aspect of the invention, the system further includes at least one calibrator for calibrating each differential amplifier. The at least one calibrator is adapted to provide a constant voltage increment to emulate the cell voltage and common-mode voltage at terminals of each cell, from the plurality of cells connected in series, for calibrating each of the differential amplifiers. The constant voltage increment may be chosen in the range of 0.5 V to 1 V. More preferably, the constant voltage increment may be 0.75 V. The system may further comprise at least one voltmeter for measuring the voltage at the inputs and the output of each differential amplifier.

In another aspect of the invention, there is provided a method for monitoring cell voltages for a plurality of electrochemical cells connected in series and having output terminals, the method comprising the steps of:

(a) connecting the voltage from two terminals of the plurality of cells connected in series to the inputs of a differential amplifier having two inputs and one output;

(b) rejecting the common-mode voltage from the voltages at the two terminals, in the differential amplifier, to give the voltage differential between the two terminals; and,

(c) converting the voltage differential from analog to digital values.

More particularly the method includes,

(1) in step (a), measuring the voltages across a plurality of pairs of terminals by connecting the voltages from each pair of terminals to a respective differential amplifier, each differential amplifier having two inputs and one output;

(2) in step (b), rejecting a common-mode voltage in each differential amplifier to give a voltage differential; and,

(3) converting each voltage differential from analog to digital values.

The method further includes connecting the output of the differential amplifiers through a switching network to an analog to digital converter, using the switching network to switch the output of one of the differential amplifiers to the analog to digital converter for analog to digital conversion of the voltage differential at the output of said one differential amplifier. The method also includes providing a controller for controlling the switching network and the analog to digital converter. The method further includes providing the controller as a microprocessor.

The method further includes the step of:

(d) providing known voltages to the inputs of the differential amplifiers and measuring the voltages and the outputs thereof, to calibrate the differential amplifiers. The method further includes providing the voltages from a calibrator and measuring the voltages with a voltmeter.

The method further includes effecting step (d) for each differential amplifier according to the steps of:

(e) applying a voltage V_{A} across the inputs of the differential amplifier and measuring V_{A};

(f) measuring the analog to digital converter output (V_{ADC}(V_{A}))) when V_{A} is applied differentially to the inputs of the differential amplifier;

(g) measuring the analog to digital converter output (V_{ADC}(V₀)) when the inputs of the differential amplifier are connected to ground; and,

(h) measuring the DC offset voltage (V_{OFF}) at the output of the differential amplifier when the inputs are tied to ground.

The method further includes effecting step (d) by using the digital values and V_{A}, V_{ADC}(V_{A}), V_{ADC}(V₀) and V_{OFF}.

The method further includes calculating the cell voltage (V_{R}) based on a measured voltage (V_{ADC}) using the formula:

$${V}_{R} = \frac{{V}_{A} \cdot {V}_{ADC}}{[ {V}_{ADC} ( {V}_{A} ) - {V}_{ADC} ( {V}_{0} ) ]} - {V}_{OFF}$$

The method further includes providing differential amplifiers which each have a high common-mode rejection ratio. More preferably, each differential amplifier can reject a common-mode voltage of 200 V.

The method further includes providing each calibrator with a constant voltage increment to emulate the cell voltage and common-mode voltage that would be expected, under normal operating conditions, at the terminals of a cell from the plurality of cells connected in series. The constant voltage increment may be selected in the range of 0.5 V to 1 V. More preferably, the constant voltage increment is 0.75 V.

The method further includes monitoring the cell voltage of each cell in the plurality of cells sequentially. Alternatively, the cell voltage of any cell, from the plurality of cells, can be measured at any time. The method further comprises applying the measurement method to fuel cell voltages.

Further objects and advantages of the present invention will appear from the following description, taken together with the accompanying drawings.

### DETAILED DESCRIPTION OF THE DRAWINGS

For a better understanding of the present invention and to show more clearly how it may be carried into effect, reference will now be made, by way of example, to the accompanying drawings which show a preferred embodiment of the present invention and in which:

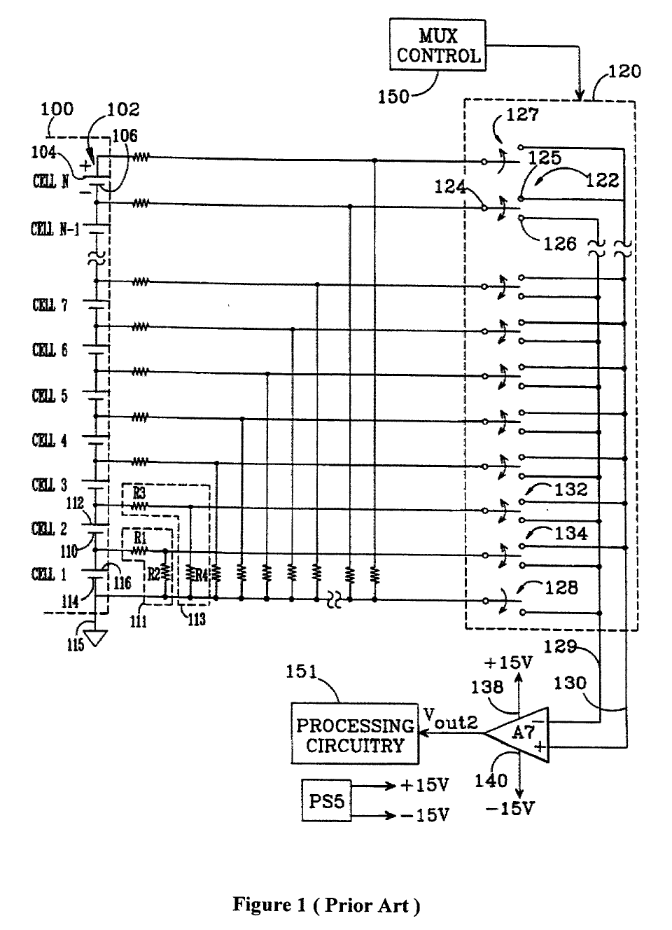

FIG. 1 is a schematic of a prior art cell voltage monitoring system;

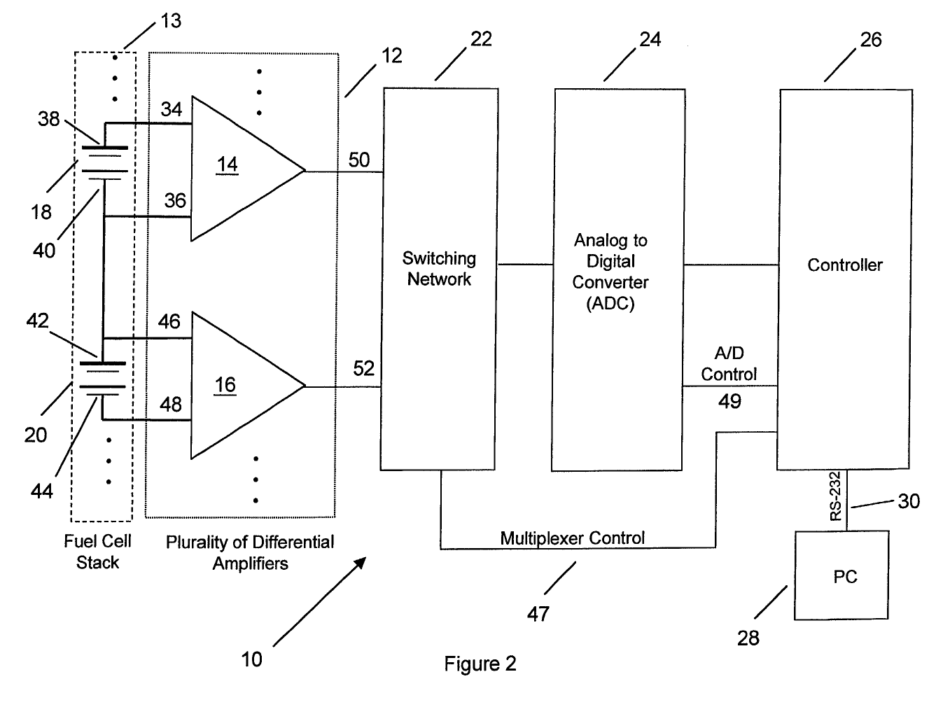

FIG. 2 is a schematic of an embodiment of a fuel cell voltage monitoring system in accordance with the present invention;

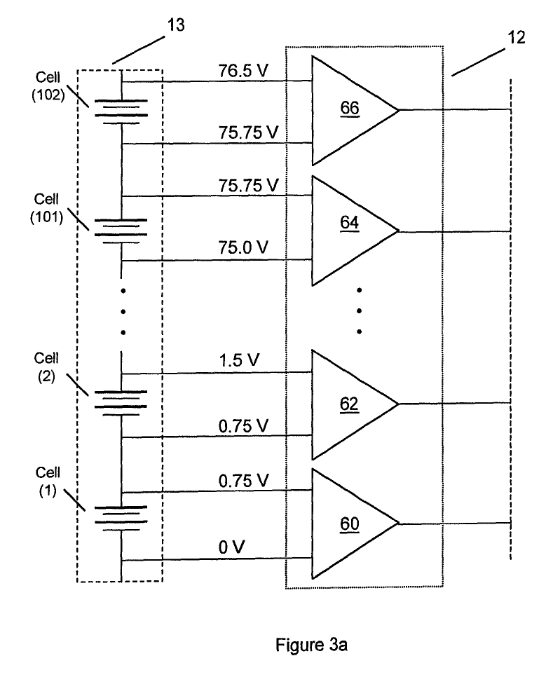

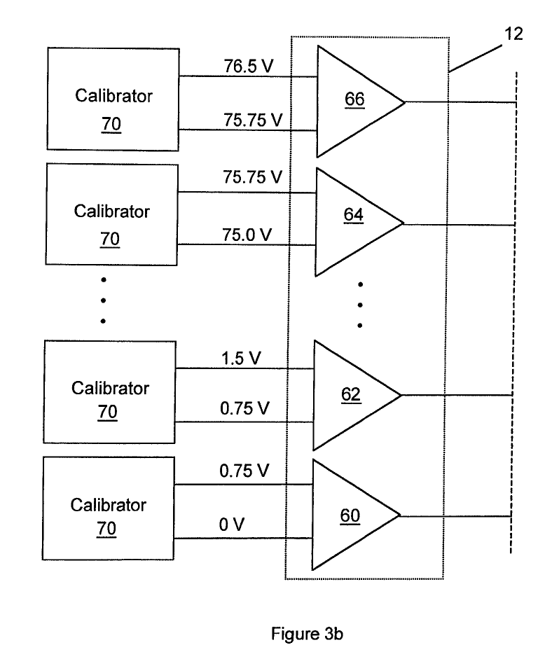

FIG. 3a is a partial view of an example of cell voltage measurement on a fuel cell stack using the fuel cell voltage monitoring system of FIG. 2; and,

FIG. 3b is a partial view of the calibration required for the fuel cell voltage monitoring system of FIG. 2.

### DETAILED DESCRIPTION OF THE PREFERRED EMBODIMENT

Referring first to FIG. 1, the system disclosed by Becker-Irvin (U.S. Pat. No. 5,914,606) is shown. Measurement points 114 and 116 are connected to the inputs of a voltage divider 111. Other measurement points are also connected to respective inputs of other voltage dividers. All the divider outputs are connected to a multiplexer 120 that has outputs 129 and 130. These outputs are connected to a differential amplifier A7. By appropriately closing switches, such as 124 and 127, the two voltage divider outputs are connected to the multiplexer 120. When the voltage dividers are “closely matched”, the output of the differential amplifier A7 will be directly proportional to the differential voltage between the pair of points at which the voltage dividers were connected. However, as previously discussed, extremely high precision resistors must be used in the voltage dividers. Further, any deviation in the resistance of these resistors will result in improper cell voltage measurement.

Referring now to FIG. 2, in accordance with the present invention, a schematic of a fuel cell voltage monitoring system is indicated at 10. The fuel cell voltage monitoring system 10 comprises a plurality of differential amplifiers 12 which are connected to a fuel cell stack 13. For simplicity, only two differential amplifiers 14 and 16 and two fuel cells 18 and 20 are shown. The fuel cell voltage monitoring system 10 further comprises a switching network 22, an analog to digital converter (ADC) 24, a controller 26 and a PC 28. The inputs of the plurality of differential amplifiers 12 are connected to the terminals of the fuel cells in the fuel cell stack 13 and the outputs of the plurality of differential amplifiers 12 are connected to the switching network 22. The switching network 22 is also connected to the ADC 24. The ADC 24 is connected to the controller 26 which is in turn connected to the PC 28 via an RS 232 cable 30 or any other commercially available PC communication link.

To effect cell voltage measurement, a plurality of differential amplifiers 12 are used wherein each differential amplifier has a high common-mode rejection ratio. Each differential amplifier preferably is also highly linear Each amplifier may have a gain of substantially unity. Each amplifier should also be able to reject as high a voltage as possible at each input. However, the input differential is limited by the power supply voltage as is commonly known in the art. Accordingly, the input differential may be limited to a range of +/−15 V.

In FIG. 2, each differential amplifier, from the plurality of differential amplifiers 12, is connected to the terminals of a respective fuel cell, in the fuel cell stack 13, whose cell voltage is to be measured. For instance, in FIG. 2, differential amplifier 14 is connected across fuel cell 18. In particular, the two inputs 34 and 36 of the differential amplifier 14 are connected to the anode 38 and the cathode 40 of the fuel cell 18. Alternatively, in practice, the inputs of a differential amplifier, chosen from the plurality of differential amplifiers 12, do not necessarily have to be connected to the two terminals of one fuel cell. Rather the inputs of the differential amplifier may be connected to any two terminals on the fuel cell stack 13 as desired. For instance, for differential amplifier 14, the input 34 may be connected to the terminal 38 of fuel cell 18 and the input 36 may be connected to the terminal 44 of fuel cell 20. In this description, for simplicity, each differential amplifier is assumed to be connected to the terminals of a unique fuel cell.

In the fuel cell voltage monitoring system 10, the output of each differential amplifier, from the plurality of differential amplifiers 12, is then connected to the inputs of the switching network 22. Accordingly, in FIG. 2, the output 50 of the differential amplifier 14 and the output 52 of the differential amplifier 16 are connected to the inputs of the switching network 22 (only two inputs are shown for simplicity). Preferably, the switching network 22 may be a multiplexer or the like. The switching network 22 only allows the differential voltage measured at two points on the fuel cell stack 13 to be accessed at any one time. This configuration is desirable for reducing the number of components in the fuel cell voltage monitoring system 10. The cell voltages may also be monitored at a high speed so that measuring only one cell voltage at a time is acceptable. The differential voltage measured at the two terminals on the fuel cell stack 13 are then sent from the switching network 22 to the ADC 24.

The ADC 24 converts the measured analog voltages to digital values. In practice, the ADC 24 may be a 16-bit ADC. Alternatively, an ADC with more bits may be used to obtain more accurate digital values. After the analog to digital conversion, the digital values are sent to the controller 26.

The controller 26 controls the function of the fuel cell voltage monitoring system 10. In particular, the controller 26 controls the operation of the switching network 22 via a switching network control signal 47 and the ADC 24 via an ADC control signal 49. The controller 26 controls the switching network 22 to selectively receive the digital values for the cell voltage measured at the two terminals of a specific fuel cell in the fuel cell stack 13. Preferably, the controller 26 directs the switching network 22 to access the voltage measured across each fuel cell in the fuel cell stack 13 in sequential order and reads the corresponding digital values from the ADC 24. Alternatively, the measured voltage across any fuel cell can be accessed at any time by appropriately programming the controller 26. The controller is preferably a microprocessor but may also be another control device such as a PLC or the like.

The controller 26 can also include a calculating means for converting the digital values read from the ADC 24 into a measured cell voltage (further explained below). Preferably, the controller 26 is further connected to a PC 28 via an RS232 cable 30 or the like which can be used to provide enhanced data processing to monitor fuel cell performance. The cell voltages allow a user to assess the overall condition of an individual fuel cell. The cell voltages can be used to determine if there is water accumulation in a cell, or if gases are mixing, etc. How often cell voltages are measured is also important. Cell voltage measurement must be sufficiently fast to report brief, transient conditions on the cells. It is preferred to perform a measurement every 10 ms on every cell, which has been shown to be more than sufficient. Note that PC 28 may be in a remote location.

The plurality of differential amplifiers 12 used in the fuel cell voltage monitoring system 10 may be chosen from any commercially available differential amplifier having a high common-mode rejection ratio. Examples include the Burr-Brown INA 117 differential amplifier or the Analog Devices AD629 differential amplifier. These differential amplifiers can function with a common-mode voltage of up to 200 V and can therefore be connected directly to the cathode and anode of a fuel cell from the fuel cell stack 13 as shown in FIG. 2.

In practice, the fuel cell voltage monitoring system 10 requires calibration in order to obtain accurate voltage measurements. As is well known to those skilled in the art, when the number of individual fuel cells in the fuel cell stack 13 increases, the voltages at the two terminals of a single fuel cell increases. This increase is larger the further away the single fuel cell is from the reference potential of the fuel cell stack 13. Accordingly, the common-mode voltage of the inputs of the differential amplifier connected to the single fuel cell also increases (the common-mode voltage is simply the average value of the inputs). The common-mode voltage of the inputs to the differential amplifier results in a voltage at the output of the differential amplifier which will corrupt the voltage measurement of the differential amplifier. This common-mode voltage error is equal to product of the common-mode voltage gain of the differential amplifier and the common-mode voltage of the inputs. Thus, the common-mode voltage error is proportional to the common-mode voltage of the inputs of the differential amplifier. Accordingly, the differential amplifier preferably has a high common-mode rejection ratio (CMRR) which is the ratio of the input voltage when the inputs are tied together divided by the output voltage. The CMRR is usually expressed in dB (i.e. CMRR (dB)=20 log (input voltage/output voltage)). Typically, values for CMRR are approximately in the range of 70 to 110 dB. An amplifier with a high common-mode rejection ratio, by definition, has a small common-mode voltage gain.

In addition, due to unavoidable internal mismatches in the differential amplifier, an extraneous voltage occurs at the output of the differential amplifier. This output voltage is referred to as the DC offset of the differential amplifier. The DC offset is observed as a finite voltage at the output of the differential amplifier when the inputs of the differential amplifier are connected to ground.

Furthermore, there is another voltage error which occurs in the measurement process which is due to the quantization noise of the ADC 24. However, as is well known in the art, the quantization noise can be reduced to an acceptable level by increasing the number of quantization bits in the ADC 24.

Due to the common-mode voltage error, the DC offset and to some extent the quantization noise, the output of the differential amplifier will deviate from the actual cell voltage of the fuel cell. This deviation is referred to as a residual voltage which is a measurement error that cannot be eliminated with common differential amplifier arrangements. As discussed previously, the residual voltage is proportional to the common-mode voltage of the inputs of the differential amplifier. This is not desirable since as the total number of individual fuel cells increase, the common-mode voltage of the inputs of the differential amplifier increase. Therefore, the deviation in the measured cell voltage for those fuel cells at the top of the fuel cell stack 13 will be large enough to significantly affect the accuracy of the cell voltage measurement.

The above problem can be overcome if the measured cell voltage of the fuel cell is calculated based on a linear equation which uses the digital values obtained from the voltage measurement of each fuel cell. In order to perform the calculation, at least one voltmeter and a calibrator (both are not shown) are needed for reading voltage values during a calibration process. Preferably, the voltmeter is a high precision voltmeter.

The cell voltage for each fuel cell, measured by a given differential amplifier, can be calculated using the following equation:

$${V}_{R} = \frac{{V}_{A} \cdot {V}_{ADC}}{[ {V}_{ADC} ( {V}_{A} ) - {V}_{ADC} ( {V}_{0} ) ]} - {V}_{OFF} \qquad ( 3 )$$

where:

V_{R} is the calibrated measured cell voltage

V_{ADC} is the output value of the ADC 24 during the cell voltage measurement

V_{A} is the voltage applied differentially to the input of the differential amplifier during calibration

V_{ADC}(V_{A}) is the output value of the ADC 24 when V_{A} is applied to the inputs of the differential amplifier during calibration

V_{ADC}(V₀) is the output value of the ADC 24 when the inputs of the differential amplifier are tied to ground during calibration

V_{OFF} is the voltage output of the differential amplifier when the inputs of the differential amplifier are tied to ground during calibration

Equation 3 removes the measurement errors to obtain the measured cell voltage for the fuel cell being measured. The voltage V_{OFF} represents the DC offset and common mode voltage errors. These errors are removed from the measured value since, based on the principle of superposition, the measured voltage will be the addition of the cell voltage plus these errors. Secondly, the factor V_{ADC}/[V_{ADC}(V_{A})−V_{ADC}(V₀)] is used to correlate the output of the ADC 24 to a meaningful value in Volts.

This calculation may be carried out by the controller 26. Alternatively, another processing device may be used. The calibrated data may then be read by the PC 28 for recording and analysis. By controlling the switching network 22 to access each differential amplifier from the plurality of differential amplifiers 12 in sequence, the cell voltage for each fuel cell in the fuel cell stack 13 can be obtained.

FIG. 3a illustrates the measurement error which occurs when measuring the cell voltage of a fuel cell, from the fuel cell stack 13, if calibration is not used. Assuming there are 102 fuel cells in the fuel cell stack 13 and that each fuel cell operates at 0.75 V (i.e. the cell voltage is 0.75 V), the actual common-mode voltage of the 102^{nd} fuel cell is 75.75 V (i.e. 0.75*101) as shown in FIG. 3a. If a residual voltage error of +50 mV occurs at the output of the differential amplifier 66 connected to the 102^{nd} fuel cell, the output of the differential amplifier 66 will be 0.8 V (i.e. 0.75+0.05) instead of 0.75 V and it has unity gain. Typically it is expected that voltages can vary in the range up to 5 Volts.

Referring now to FIG. 3b, the measurement error can be eliminated by calibrating the differential amplifier 66 with a calibrator 70 that provides the exact common-mode voltage and cell voltage that would be expected for the 102^{nd} fuel cell which in this example are 75.75 V and 0.75 V respectively. When the calibrator is employed to calibrate the differential amplifier 66, the common-mode voltage error and the DC offset of the differential amplifier will be obtained. However, during measurement, the output of the differential amplifier 66 will be the same as it was before calibration was performed (i.e. 0.80 V in the example). Thus, equation 3 must be used to obtain the actual cell voltage and significantly reduce the residual error.

Although it is difficult to know the actual cell voltage of each fuel cell, it is known that individual fuel cells operate between approximately 0.5 V to 1.0 V during normal operation. By applying a calibrator that provides voltage levels close to these cell voltages, the plurality of differential amplifiers 12 may be calibrated before they are used to measure the cell voltages of fuel cells in the fuel cell stack 13. Therefore, the common-mode voltage error and the DC offset of each differential amplifier can be obtained. Consequently, by calibrating each differential amplifier, the accuracy of the fuel cell voltage monitoring system 10 considerably increases.

Since individual fuel cells operate in the range of 0.5 V to 1.0 V, each fuel cell may be assumed to have a cell voltage of 0.75 V. This is an average voltage at which fuel cells operate during normal use. Therefore, during calibration an increment of 0.75 V is used which means the calibrator provides voltages as if the upper terminal of fuel cell 1 is at 0.75 V, the upper terminal of fuel cell 2 is at 1.5 V, the upper terminal of fuel cell 3 is at 2.25 V and the upper terminal of fuel cell 101 is at 76.5 V, as shown in FIG. 3b. The inventor has found that by using this method in practice, each differential amplifier was calibrated at a common-mode voltage which was close to the actual common-mode voltage at the cell terminals of each fuel cell when each fuel cell was operating under ideal conditions. As a result, the measured cell voltages were close to the actual cell voltage of each fuel cell.

Although the calibration method does not completely eliminate the residual error, it significantly reduces the residual error and most notably the common-mode voltage error. Further, after calibration, the common-mode voltage error occurring during the voltage measurement of a given differential amplifier is no longer proportional to the common-mode voltage at the inputs of the differential amplifier. The common-mode voltage error is now proportional to the difference between the actual common-mode voltage at the inputs and the assumed common-mode voltage that was used for each fuel cell during calibration. This difference is random and does not increase as the number of fuel cells in the fuel cell stack 13 increase. Therefore, the common-mode voltage error is maintained at a very low level during cell voltage measurement. This is particularly advantageous when measuring the cell voltage of fuel cells in a large fuel cell stack.

The fuel cell voltage monitoring system 10 according to the present invention uses commonly available components which are inexpensive and do not require any hardware adjustments. The present invention also provides for a simple to use and highly precise measurement system. Furthermore, compared to existing cell voltage monitoring systems, the present invention has fewer components which significantly reduces the overall size of the system. Therefore, the fuel cell voltage monitoring system 10 can be easily incorporated into any fuel cell testing device.

It should be appreciated that the present invention is intended not only for monitoring the voltages of individual fuel cells, in fuel cell stacks, but also for monitoring the voltages in any kind of multi-cell battery formed by connecting individual cells in series. The present invention can also be used to monitor the voltage of a single cell, a battery, a battery bank or an electrolyser.

It should be further understood that various modifications can be made, by those skilled in the art, to the preferred embodiments described and illustrated herein, without departing from the present invention, the scope of which is defined in the appended claims.

I claim:

1. A system for monitoring at least one cell voltage of an electrochemical device for a plurality of cells connected in series, the system comprising:
a plurality of differential amplifiers, each differential amplifier having two inputs and one output, wherein the inputs are each connected, in use, to the plurality of cells;
a switching network having a plurality of inputs and one output, the inputs of the switching network connected to the outputs of the differential amplifiers;
an analog to digital converter having an input connected to the output of the switching network and adapted to provide digital values indicative of the voltages measured by the plurality of differential amplifiers; and,
a controller connected to the switching network and the analog to digital converter to control the operation of the switching network and the analog to digital converter, wherein the controller is further adapted to receive the digital values from the output of the analog to digital converter.

2. A system as claimed in claim 1, wherein the system further includes a calculating means, connected to the output of one of the analog to digital converter and the controller, to calculate the at least one cell voltage based on the digital values.

3. A system as claimed in claim 1, wherein each differential amplifier has a high common-mode rejection ratio.

4. A system as claimed in claim 3, wherein each differential amplifier is adapted to reject a common-mode voltage of 200 V.

5. A system as claimed in claim 1, wherein the controller includes a calculating means.

6. A system as claimed in claim 1, wherein the controller comprises a microprocessor.

7. A system as claimed in claim 1 or 2, wherein the system further comprises a computer and the controller is connected to the computer.

8. A system as claimed in claim 1 or 2, wherein the system further comprises at least one calibrator, connectable to each differential amplifier, for calibrating each differential amplifier.

9. A system as claimed in claim 8, wherein the at least one calibrator is adapted to provide a constant voltage increment to emulate the cell voltage and common-mode voltage at terminals of each cell, from the plurality of fuel cells connected in series, for calibrating each of the differential amplifiers.

10. A system as claimed in claim 9, wherein the constant voltage increment is chosen in the range of 0.5 V to 1 V.

11. A system as claimed in claim 10, wherein the constant voltage increment is 0.75 V.

12. A system as claimed in claim 8, wherein the system further includes, for calibration, at least one voltmeter for measuring the voltage at the inputs and the output of each differential amplifier.

13. A method for monitoring cell voltages for a plurality of electrochemical cells connected in series and having output terminals, the method comprising the steps of:
(a) connecting the voltage from two terminals of the plurality of cells connected in series to the inputs of a differential amplifier having two inputs and one output;
(b) rejecting the common-mode voltage from the voltages at the two terminals, in the differential amplifier, to give the voltage differential between the two terminals; and,
(c) converting the voltage differential from analog to digital values.

14. A method as claimed in claim 13, which includes:
(1) in step (a), measuring the voltages across a plurality of pairs of terminals by connecting the voltages from each pair of terminals to a respective differential amplifier, each differential amplifier having two inputs and one output;
(2) in step (b), rejecting a common-mode voltage in each differential amplifier to give a voltage differential; and,
(3) converting each voltage differential from analog to digital values.

15. A method as claimed in claim 14, which includes connecting the outputs of the differential amplifiers through a switching network to an analog to digital converter, using the switching network to switch the output of one of the differential amplifiers to the analog to digital converter for analog to digital conversion of the voltage differential at the output of said one differential amplifier.

16. A method as claimed in claim 15, which includes providing a controller for controlling the switching network and the analog to digital converter.

17. A method as claimed in claim 16, which includes providing the controller as a microprocessor.

18. A method as claimed in claim 14, wherein the method further includes the step of:
(d) providing known voltages to the inputs of the differential amplifiers and measuring the voltages and the outputs thereof, to calibrate the differential amplifiers.

19. A method as claimed in claim 18, wherein the method includes providing the voltages from a calibrator and measuring the voltages with a voltmeter.

20. A method as claimed in claim 18, wherein the method includes effecting step (d) for each differential amplifier according to the steps of:
(e) applying a voltage V_{A} across the inputs of the differential amplifier and measuring V_{A};
(f) measuring the analog to digital converter output (V_{ADC}(V_{A}))) when V_{A} is applied differentially to the inputs of the differential amplifier;
(g) measuring the analog to digital converter output (V_{ADC}(V₀)) when the inputs of the differential amplifier are connected to ground; and,
(h) measuring the DC offset voltage (V_{OFF}) at the output of the differential amplifier when the inputs are tied to ground.

21. A method as claimed in claim 20, wherein step (d) is effected using the digital values and V_{A}, V_{ADC}(V_{A}), V_{ADC}(V₀) and V_{OFF}.

22. A method as claimed in claim 20 or 21, which includes calculating the cell voltage (V_{R}) based on a measured voltage (V_{ADC}) using the formula:
$${V}_{R} = \frac{{V}_{A} \cdot {V}_{ADC}}{[ {V}_{ADC} ( {V}_{A} ) - {V}_{ADC} ( {V}_{0} ) ]} - {V}_{OFF}$$

23. A method as claimed in claim 13, which includes providing each differential amplifier with a high common-mode rejection ratio.

24. A method as claimed in claim 13, which includes providing differential amplifiers which can accommodate a common-mode voltage of 200 V.

25. A method as claimed in claim 22, which includes providing each calibrator with a constant voltage increment to emulate the cell voltage and common-mode voltage that would be expected, under normal operating conditions, at the terminals of a cell from the plurality of cells connected in series.

26. A method as claimed in claim 25, which includes selecting the constant voltage increment in the range of 0.5 V to 1 V.

27. A method as claimed in claim 26, which includes selecting the constant voltage increment to be 0.75 V.

28. A method as claimed in claim 13, which includes monitoring the cell voltage of each cell in the plurality of cells sequentially.

29. A method as claimed in claim 13, which includes monitoring the cell voltage of any cell from the plurality of cells at any time.

30. A method as claimed in claim 13, comprising applying the method to measurement of fuel cell voltages.
